(19) United States
(12) Patent Application Publication
(10) Pub. No.: US 2019/0171226 A1
(43) Pub. Date: Jun. 6, 2019

(54) PLATOONING CONTROL APPARATUS AND METHOD THEREFOR

(71) Applicants: HYUNDAI MOTOR COMPANY, Seoul (KR); KIA MOTORS CORPORATION, Seoul (KR)

(72) Inventor: Dong Hyuk KIM, Hwaseong-si (KR)

(73) Assignees: HYUNDAI MOTOR COMPANY, SEOUL (KR); KIA MOTORS CORPORATION, SEOUL (KR)

(21) Appl. No.: 15/899,159

(22) Filed: Feb. 19, 2018

(30) Foreign Application Priority Data
Dec. 1, 2017 (KR) 10-2017-0164061

(51) Int. Cl. G05D 1/02; G05D 1/00; H04W 4/46; B60W 30/16

(52) U.S. Cl. CPC G05D 1/0293; G05D 1/0289; B60W 30/16; H04W 4/46; G05D 1/0027

(57) ABSTRACT

The present disclosure provides a platooning control apparatus and a platooning control method. The platooning control apparatus includes a communication unit configured to perform wireless communication with at least one vehicle that forms a platooning line with a host vehicle, a detector configured to detect a braking state of the host vehicle, and a controller configured to adjust an amount of braking control of the host vehicle when a preceding vehicle of the host vehicle is changed, wherein the amount of the braking control of the host vehicle is adjusted based on whether the braking state of the host vehicle meets an adjusting mode and based on a braking performance of each of the preceding vehicle and the host vehicle.

### CROSS-REFERENCE TO RELATED APPLICATION

The present application claims priority to and the benefit of Korean Patent Application No. 10-2017-0164061, filed on Dec. 1, 2017, which is incorporated herein by reference in its entirety.

### FIELD

The present disclosure relates to a platooning control apparatus for adjusting an amount of longitudinal control of a host vehicle in consideration of braking performance of each of a preceding vehicle and the host vehicle upon platooning and controlling a vehicle to vehicle (V2V) distance from the preceding vehicle and a method therefor.

### BACKGROUND

The statements in this section merely provide background information related to the present disclosure and may not constitute prior art.

Platooning may be a manner of exchanging motion and context information of a leading vehicle through real-time V2V communication, maintaining a predetermined interval from the leading vehicle, and driving several vehicles together. Since a host vehicle drives while maintaining the predetermined interval from the leading vehicle, such platooning reduces air resistance of a following vehicle to reduce fuel efficiency and may decrease the risk of an accident.

In the related art, acceleration or deceleration torque values provided from a leading vehicle and information about a distance from a preceding vehicle may be used for longitudinal control of platooning vehicles. However, since there are various types of commercial vehicles and since braking performance differs even within the same vehicle model, there may be a limit on control of a V2V distance when an emergency situation occurs.

### SUMMARY

An aspect of the present disclosure provides a platooning control apparatus for adjusting an amount of longitudinal control of a host vehicle in consideration of braking performance of each of a preceding vehicle and the host vehicle upon platooning and controlling a V2V distance from the preceding vehicle and a method therefor.

In one aspect of the present disclosure, a platooning control apparatus may include: a communication unit configured to perform wireless communication with at least one vehicle that forms a platooning line with a host vehicle, a detector configured to detect a braking state of the host vehicle, and a controller configured to, when a preceding vehicle of the host vehicle is changed, adjust an amount of braking control of the host vehicle based on whether the braking state of the host vehicle meets an adjusting mode and based on a braking performance of each of the preceding vehicle and the host vehicle.

The communication unit may be configured to use vehicle to vehicle (V2V) communication.

The preceding vehicle may be a vehicle immediately before the host vehicle in the platooning line.

The detector may include a speed detector configured to detect a deceleration of the host vehicle.

The controller may be configured to determine whether the deceleration of the host vehicle is within a reference range and is maintained for a predetermined amount of time.

The controller may be configured to calculate a correction value based on an initial deceleration requirement of the host vehicle, a deceleration requirement of the host vehicle, an actual deceleration of the host vehicle; a deceleration requirement of the preceding vehicle; and an actual deceleration of the preceding vehicle.

The controller may be configured to, when the braking state of the host vehicle does not meet the adjusting mode, determine whether the braking state of the host vehicle is an emergency braking state and, when the braking state of the host vehicle is the emergency braking state, adjust the deceleration requirement of the host vehicle with a predetermined rate.

The controller may be configured to adjust the deceleration requirement of the host vehicle to 1.3 times of the deceleration requirement of the host vehicle.

The controller may be configured to, after adjusting the amount of the braking control of the host vehicle, determine whether the host vehicle is a tail end vehicle of the platooning line, when the host vehicle is the tail end vehicle of the platooning line, check a braking operation of the host vehicle, and adjust the amount of the braking control of the host vehicle based on the braking operation of the host vehicle.

The controller may be configured to, when the host vehicle is not the tail end vehicle of the platooning line, instruct a following vehicle to adjust an amount of braking control of the following vehicle.

The controller may be configured to control the braking operation of the host vehicle at a predetermined deceleration requirement of the host vehicle for a predetermined amount of time, measure the actual deceleration of the host vehicle, and determine whether a difference between the actual deceleration of the host vehicle and the predetermined deceleration requirement is within an allowable error range.

In another aspect of the present disclosure, a platooning control method may include: when a host vehicle and at least one vehicle form a platoon line, determining whether a preceding vehicle is changed, when the preceding vehicle is changed, determining whether a braking state of the host vehicle meets an adjusting mode, when the braking state of the host vehicle meets the adjusting mode, adjusting an amount of braking control of the host vehicle based on a braking performance of the preceding vehicle, and controlling braking of the host vehicle based on the amount of the braking control of the host vehicle that is adjusted based on the braking performance of the preceding vehicle.

The host vehicle may be configured to transmit and receive data with the at least one vehicle using V2V communication.

The preceding vehicle may be a vehicle immediately before the host vehicle in the platooning line.

Determining whether the braking state of the host vehicle meets the adjusting mode may include determining whether a deceleration of the host vehicle is within a reference range and is maintained for a predetermined amount of time.

Adjusting the amount of the braking control of the host vehicle may include calculating a correction value based on an initial deceleration requirement of the host vehicle, a deceleration requirement of the host vehicle, and an actual deceleration of the host vehicle; a deceleration requirement of the preceding vehicle; and an actual deceleration of the preceding vehicle.

Determining whether the braking state of the host vehicle meets the adjusting mode may include, when the braking state of the host vehicle does not meet the adjusting mode, determining whether the braking state of the host vehicle is an emergency braking state and, when the braking state of the host vehicle is the emergency braking state, calculating the deceleration requirement of the host vehicle based on the deceleration requirement of the preceding vehicle.

The method may further include, after adjusting the amount of the braking control of the host vehicle, determining whether the host vehicle is a tail end vehicle of the platooning line, when the host vehicle is the tail end vehicle of the platooning line, checking a braking operation of the host vehicle, and adjusting the amount of the braking control of the host vehicle based on the braking operation of the host vehicle.

Determining whether the host vehicle is the tail end vehicle of the platooning line may include, when the host vehicle is not the tail end vehicle of the platooning line, instructing a following vehicle to adjust an amount of braking control of the following vehicle.

Checking the braking operation of the host vehicle may include controlling the braking operation of the host vehicle at a predetermined deceleration requirement of the host vehicle for a predetermined amount of time and determining whether a difference between the actual deceleration of the host vehicle and the predetermined deceleration requirement of the host vehicle is within an allowable error range.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a block diagram illustrating a configuration of a platooning control apparatus;

FIG. 2 is a flowchart illustrating a platooning control method;

FIG. 3 is a graph illustrating braking performance of a vehicle before adjusting an amount of braking control; and

FIG. 4 is a graph illustrating braking performance of a vehicle according to adjusting an amount of braking control.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Hereinafter, forms of the present disclosure will be described in detail with reference to the accompanying drawings. In adding reference denotations to elements of each drawing, although the same elements are displayed on a different drawing, it should be noted that the same elements have the same denotations. In addition, in describing a form of the present disclosure, when it is determined that a detailed description of related well-known configurations or functions blurs the gist of a form of the present disclosure, it will be omitted.

In describing elements of forms of the present disclosure, the terms 1^{st}, 2^{nd}, first, second, A, B, (a), (b), and the like may be used herein. These terms are only used to distinguish one element from another element, but do not limit the corresponding elements irrespective of the nature, turn, or order of the corresponding elements. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

Platooning may mean that one leading vehicle and one or more following vehicles form a platoon and drive. In the specification, a leading vehicle may refer to a vehicle which is at the forefront of a platooning vehicle line (a platooning line). A following vehicle may refer to a vehicle which follows the leading vehicle. A tail end vehicle may refer to a vehicle which is at the very end of the platooning line. A preceding vehicle may refer to a vehicle immediately before a vehicle (a host vehicle).

The present disclosure relates to adjusting an amount of longitudinal control (an amount of braking control) of a vehicle in consideration of braking performance of a preceding vehicle which is a vehicle immediately before a host vehicle when performing platooning. Herein, the braking performance may be a time taken for an actual deceleration of a vehicle to arrive at 90% of a deceleration requirement and may refer to a control response speed (responsibility) upon braking control.

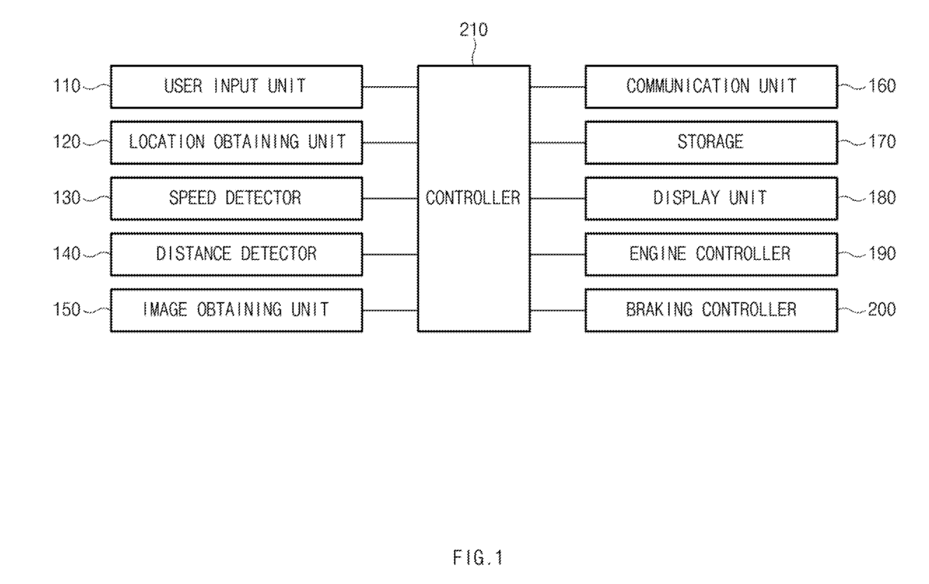

FIG. 1 is a block diagram illustrating a configuration of a platooning control apparatus in some forms of the present disclosure.

As shown in FIG. 1, the platooning control apparatus may include a user input unit 110, a location obtaining unit 120, a speed detector 130, a distance detector 140, an image obtaining unit 150, a communication unit 160, a storage 170, a display unit 180, an engine controller 210, a braking controller 200, and a controller 210.

The user input unit 110 may generate input data according to an operation of a user. The user input unit 110 may include a separate switch which generates a signal (command) such as a platooning request or a platooning acceptance. The user may operate the switch to provide a platooning request or provide a platooning acceptance for a platooning request.

The user input unit 110 may be composed of at least one or more of input means such as a keypad, a dome switch, a (resistive/capacitive) touch pad, a jog wheel, and a jog switch.

The location obtaining unit 120 may receive a signal transmitted from a satellite and may determine a location of a vehicle terminal (or a vehicle). The location obtaining unit 120 may be implemented as a global positioning system (GPS) receiver, or two or more location obtaining units may be installed. The GPS receiver may calculate a current location of a vehicle using signals received from three or more GPS satellites.

The speed detector 130 may detect a driving speed of a host vehicle (a vehicle speed). Further, the speed detector 130 may detect acceleration and deceleration other than a vehicle speed through a speed sensor, an acceleration sensor, or an electric control unit (ECU) which is mounted on the host vehicle.

The distance detector 140 may detect (measure) a distance between a vehicle immediately before or after the vehicle (the host vehicle) and the vehicle (the host vehicle). For example, the distance detector 140 may detect a distance between the vehicle and a preceding vehicle or a distance between the vehicle and a following vehicle immediately after the vehicle. Information about a vehicle to vehicle (V2V) distance detected by the distance detector 140 may be used to calculate a relative distance, a relative speed, and the like.

Such a distance detector 140 may include a light detection and ranging (LiDAR), a radio detecting and ranging (RADAR), an ultrasonic sensor, and the like.

The image obtaining unit 150 may obtain an image (e.g., a front image, a rear image, and/or a lateral image) around the vehicle through one or more cameras. The image obtaining unit 150 may transmit an image obtained through the camera to the controller 210.

Herein, the camera may include at least one or more of image sensor sensors such as a charge coupled device (CCD) image sensor, a complementary metal oxide semiconductor (CMOS) image sensor, a charge priming device (CPD) image sensor, and a charge injection device (CID) image sensor. The camera may include at least one or more of lenses such as a normal lens, a super-wide-angle lens, a wide-angle lens, a zoom lens, a micro lens, a telephoto lens, a fisheye lens, and a semi fisheye lens and may include lighting such as an infrared light emitting device. Further, the camera may include an image processor for performing image processing such as noise cancellation, color reproduction, file compression, image quality adjustment, and saturation adjustment for an image obtained by an image sensor.

The image obtaining unit 150 may process an image obtained through the camera to extract lane information and may transmit the extracted lane information to the controller 210. The image obtaining unit 150 may extract lane information using lane detection technology well known.

The communication unit 160 may communicate with devices, for example, an electric control unit (ECU) mounted on the vehicle, a platooning control apparatus mounted on another vehicle (e.g., a preceding vehicle, a leading vehicle, a tail end vehicle, and/or a following vehicle), a mobile terminal (e.g., a smartphone, a computer, a laptop, a tablet, or the like), and a control center server.

The communication unit 160 may receive a map, road information, traffic situation information, platooning related information, and the like from a control center.

The communication unit 160 may use vehicle communication, vehicle to everything (V2X) communication, wireless communication, and/or the like. Controller area network (CAN) communication, media oriented systems transport (MOST) communication, local interconnect network (LIN) communication, an X-by-Wire (FlexRay) communication, or the like may be used as the vehicle communication. The V2X communication may be implemented as V2V communication, vehicle to infrastructure (V2I) communication, and/or the like.

The wireless communication may be implemented by at least one or more of communication technologies such as a wireless Internet (e.g., wireless-fidelity (Wi-Fi)), short range communication (e.g., Bluetooth, Zigbee, and infrared communication), and mobile communication.

The storage 170 may store software programmed for the controller 210 to perform a predetermined operation. Further, the storage 170 may store a map, road information, vehicle information, cargo box information, and the like and may temporarily store input/output data of the controller 210.

The storage 170 may be implemented with at least one or more of storage media, for example, a flash memory, a hard disk, a secure digital (SD) card, a random access memory (RAM), a read only memory (ROM), and a web storage.

The display unit 180 may output a state and a result according to an operation of the controller 210. The display unit 180 may display a driving speed, a remaining capacity of fuel, road guide information, a map, platooning related information, and the like.

The display unit 180 may implemented with at least one or more of a liquid crystal display (LCD), a thin film transistor-LCD (TFT LCD), an organic light-emitting diode (OLED) display, a flexible display, a three-dimensional (3D) display, a transparent display, a head-up display (HUD), and a cluster.

The display unit 180 may include a sound output module such as a speaker capable of outputting audio data. For example, the display unit 180 may display road guide information and may output a voice signal (an audio signal) through the speaker.

Further, the display unit 180 may be implemented as a touch screen combined with a touch sensor and may be used as an input device as well as an output device. A touch film, a touch pad, or the like may be used as the touch sensor.

The engine controller 190 may be an actuator for controlling an engine of the vehicle and may control the engine to control acceleration of the vehicle. The engine controller 210 may be implemented as an engine management system. The engine controller 210 may control a driving torque of the engine depending on accelerator pedal position information output from an accelerator pedal position sensor. Meanwhile, the engine controller 190 may control an engine output to follow a driving speed of the vehicle, requested from the controller 210 upon autonomous driving (platooning).

The braking controller 200 may be an actuator for controlling deceleration of the vehicle and may be implemented with electronic stability control (ESC). The braking controller 200 may control braking pressure to follow a target speed requested from the controller 210 upon autonomous driving. Thus, the braking controller 200 may control a speed of the vehicle to decelerate the vehicle.

The engine controller 190 and the braking controller 200 may be collectively called a vehicle control device. The vehicle control device may further include a lamp driving unit for driving a turn (left or right turn) lamp, a stop lamp, a platooning mode lamp, and the like.

The controller 210 may control an overall operation of the platooning control apparatus. The controller 210 may include at least one or more of an application specific integrated circuit (ASIC), a digital signal processor (DSP), programmable logic devices (PLD), field programmable gate arrays (FPGAs), a central processing unit (CPU), microcontrollers, and microprocessors.

The controller 210 may provide a request to perform platooning (form a platoon) to a leading vehicle or a control center server and may receive a response to the request to perform the platooning such that the host vehicle is a following vehicle. The response may include information associated with platooning approval and the platooning (e.g., a V2V distance, a driving speed, a deceleration requirement, an acceleration requirement, and the like).

When receiving a deceleration requirement transmitted from a preceding vehicle through the communication unit 160, the controller 210 may control the braking controller 200 based on the received deceleration requirement to control a braking operation of the vehicle. Further, when receiving a required acceleration from the preceding vehicle, the controller 210 may control the engine controller 190 based on the required acceleration to control an acceleration operation of the vehicle.

When forming a platoon and starting to perform platooning, the controller 210 may determine whether the formed platoon is a new platoon. In other words, the controller 210 may determine whether a preceding vehicle located immediately before the host vehicle is changed. The controller 210 may determine whether a preceding vehicle before the host vehicle is changed at a predetermined period.

The controller 210 may recognize a vehicle number of the preceding vehicle through the image obtaining unit 150 and may determine whether the preceding vehicle is changed. Alternatively, the controller 210 may determine whether a preceding vehicle is changed through platooning related information (platoon control information) provided from a leading vehicle or the preceding vehicle.

For example, when a new vehicle joins the host vehicle before the host vehicle during platooning, the controller 210 may recognize the joined new vehicle as a preceding vehicle and may compare a vehicle number of the recognized preceding vehicle with a vehicle number of a preceding vehicle previously recognized. When the two vehicle numbers are not identical to each other as a result of the comparison, the controller 210 may determine that the preceding vehicle is changed.

When the preceding vehicle is changed, the controller 210 may determine whether a braking state (a braking operation) of the host vehicle meets an adjusting mode. Herein, the adjusting mode may refer to a condition where a vehicle operates for one second or more at a deceleration between −2 m/s² and −3 m/s². After detecting the change in preceding vehicle, the controller 210 may control an operation of the host vehicle based on platooning control information transmitted from the leading vehicle through the communication unit 160. When a braking operation occurs, a controller of the leading vehicle may transmit a deceleration requirement according to the braking operation to a following vehicle. In other words, the controller of the leading vehicle may transmit a deceleration requirement according to braking pedal position information input by a driver of the leading vehicle or a deceleration requirement output from an autonomous driving control device to at least one or more following vehicles through V2V communication. When receiving the deceleration requirement from the leading vehicle, the controller 210 may perform a braking operation depending on the received deceleration requirement. While performing the braking operation, the controller 210 may detect a deceleration of the host vehicle through the speed detector 130. When the detected deceleration is less than −2 m/s² and is greater than −3 m/s² and is maintained for one second or more, the controller 210 may determine that a braking state of the host vehicle meets the adjusting mode.

Meanwhile, when the braking state of the host vehicle does not meet the adjusting mode, the controller 210 may determine whether the braking state of the host vehicle is an emergency braking state. When a deceleration of the host vehicle, detected through the speed detector 130, or a deceleration requirement transmitted through the communication unit 160 from the leading vehicle is less than or equal to −3 m/s², the controller 210 may recognize the braking state of the host vehicle as the emergency braking state. When determining the braking state of the host vehicle as the emergency braking state, the controller 210 may adjust a deceleration requirement received from the leading vehicle at a predetermined rate to calculate a deceleration requirement of the host vehicle. For example, the controller 210 may calculate 1.3 times of the deceleration requirement received from the leading vehicle as the deceleration requirement of the host vehicle.

When the braking state of the host vehicle meets the adjusting mode, the controller 210 may enter the adjusting mode and may calculate a correction value for adjusting a deceleration requirement of the host vehicle. The controller 210 may adjust the deceleration requirement of the host vehicle using the calculated correction value. The controller 210 may adjust the deceleration requirement using Equation 1 below.

$${a}_{corr} = {a}_{0} + {a}_{0} ( \frac{\int {a}_{real \_ PV}}{\int {a}_{req \_ PV}} - \frac{\int {a}_{real}}{\int {a}_{req}} ) \qquad [ Equation 1 ]$$

Herein, a_{corr} may be an adjusted deceleration requirement of the host vehicle, a₀ may be an initial deceleration requirement of the host vehicle, aᵣₑₐₗ_{_}_{PV} may be an actual deceleration of a preceding vehicle, a_{req}_{_}_{PV} may be a deceleration requirement of the preceding vehicle, aᵣₑₐₗ may be an actual deceleration of the host vehicle, and a_{req} may be a deceleration requirement of the host vehicle.

According to Equation 1, the controller 210 may calculate a correction value using the initial deceleration requirement a₀ of the host vehicle, a deceleration requirement accumulation value ∫a_{req} of the host vehicle, an actual deceleration accumulation value ∫aᵣₑₐₗ of the host vehicle, a deceleration requirement accumulation value ∫a_{req}_{_}_{PV} of the preceding vehicle, and an actual deceleration accumulation value ∫aᵣₑₐₗ_{_}_{PV} of the preceding vehicle. The controller 210 may add the initial deceleration requirement a₀ of the host vehicle to the calculated correction value to calculate the adjusted deceleration requirement a_{corr} of the host vehicle. The controller 210 may store the calculated correction value in the storage 170. Thereafter, when receiving a deceleration requirement, the controller 210 may adjust the deceleration requirement using the correction value and may determine an amount of braking control.

The controller 210 may perform braking of the host vehicle by applying the adjusted deceleration requirement. In this case, the controller 210 may measure an actual deceleration of the host vehicle according to braking through the speed detector 130. Further, the controller 210 may measure a time taken for the actual deceleration of the host vehicle to arrive at 90% of the deceleration requirement and a deceleration delay time (a control response speed) T_{HV delay} of the host vehicle.

The controller 210 may determine whether adjusting is completed to a tail end vehicle of a platooning line. In other words, the controller 210 may determine whether the host vehicle is the tail end vehicle of the platooning line.

When the adjusting is completed to the tail end vehicle, the controller 210 may check a braking operation. Checking the braking operation may mean that all vehicles which form a platoon simultaneously perform braking operations in the same deceleration condition (the same braking condition) and that each vehicle calculates a difference (error) between its deceleration requirement and its actual deceleration. For example, each of a leading vehicle and a following may perform braking at a deceleration of −3 m/s² for one second or more and may measure its actual deceleration through its speed detector 130.

Meanwhile, when the adjusting is not completed to the tail end vehicle, the controller 210 may instruct a following vehicle, located immediately after the host vehicle on the platooning line, to adjust an amount of braking control.

When a difference (error) between a deceleration requirement of the host vehicle and an actual deceleration of the host vehicle is within an allowable error range (e.g., 5%) as a result of the final check, the controller 210 may complete (end) the adjustment. Meanwhile, when the difference between the deceleration requirement and the actual deceleration departs from the allowable error range as a result of the final check, the controller 210 may perform a procedure of adjusting an amount of braking control again.

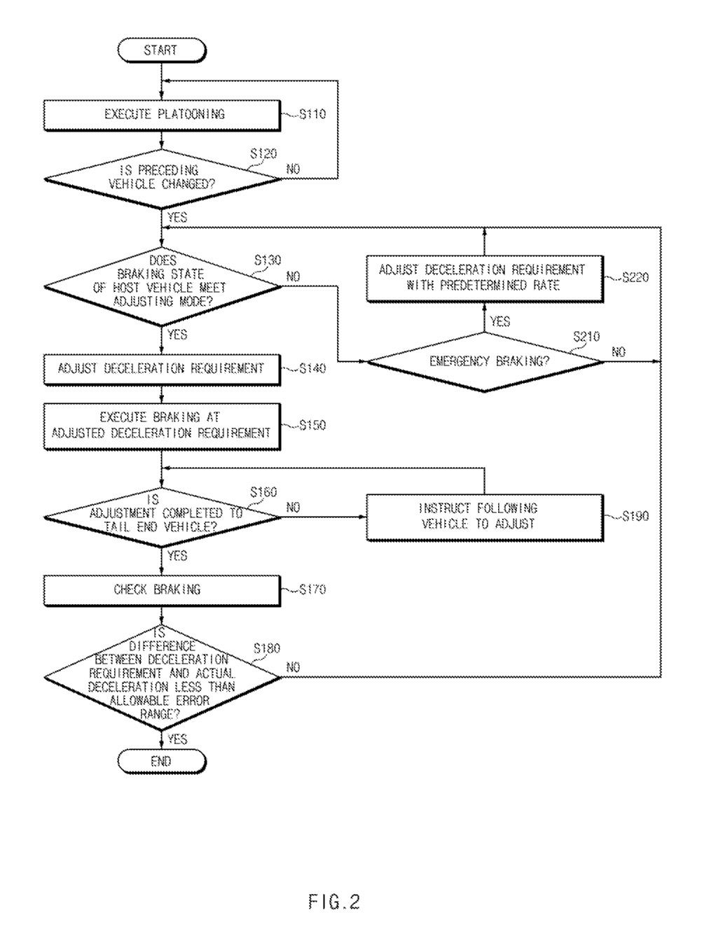

FIG. 2 is a flowchart illustrating a platooning control method in some forms of the present disclosure.

First of all, in operation S110, a controller 210 of a platooning control apparatus may request a leading vehicle to form a platoon and may execute platooning such that a host vehicle is a following vehicle. The controller 210 may receive platooning information associated with platooning through a communication unit 160 of FIG. 1 from a platooning control apparatus of the leading vehicle. The platooning information may include information, for example, a driving speed, a V2V distance, a deceleration requirement, an acceleration requirement, and a line location.

While performing the platooning, in operation S120, the controller 210 may determine whether a preceding vehicle is changed. When the platoon for platooning is formed, the controller 210 may determine whether the formed platoon is a new platoon. For example, when a new vehicle joins the platoon during the platooning, the controller 210 may recognize the platoon as a new platoon. The controller 210 may determine whether the preceding vehicle is changed through the platooning information provided from the leading vehicle, or may recognize a vehicle number of the preceding vehicle through an image obtaining unit 150 of FIG. 1 and may determine whether the preceding vehicle is changed.

When the preceding vehicle is changed, in operation S130, the controller 210 may determine whether a braking state (a braking operation) of a host vehicle meets an adjusting mode. In other words, the controller 210 may determine whether the host vehicle performs a braking operation in a specific deceleration condition. For example, the controller 210 may determine whether the host vehicle maintains a braking operation at a deceleration between −2 m/s² and −3 m/s² for one second or more using a speed detector 130 of FIG. 1.

When the braking state of the host vehicle meets the adjusting mode, in operation S140, the controller 210 may adjust a deceleration requirement of the host vehicle. When the braking state of the host vehicle meets the adjusting mode, the controller 210 may enter the adjusting mode and may calculate a correction value for adjusting the deceleration requirement of the host vehicle. The controller 210 may calculate the correction value using an initial deceleration requirement of the host vehicle, a deceleration requirement of the host vehicle, an actual deceleration of the host vehicle, a deceleration requirement of a preceding vehicle, and an actual deceleration of the preceding vehicle. The controller 210 may reflect the calculated correction value in the initial deceleration requirement of the host vehicle to adjust the deceleration requirement of the host vehicle (see Equation 1 above).

In operation S150, the controller 210 may execute braking at the adjusted deceleration requirement. The controller 210 may control a braking controller 200 of FIG. 1 at the adjusted deceleration requirement to perform a braking operation and may measure an actual deceleration of the host vehicle through the speed detector 130. Further, the controller 210 may measure a time (a control response speed) taken for an actual deceleration of the host vehicle to arrive at 90% of a deceleration requirement of the host vehicle using a timer.

In operation S160, the controller 160 may determine whether adjusting of the deceleration requirement is completed to a tail end vehicle of a platooning line. The controller 160 may determine whether the host vehicle is a last following vehicle of the platooning line.

When the deceleration requirement is adjusted with respect to the tail end vehicle, in operation S170, the controller 160 may execute a final check of a braking operation with a leading vehicle and the other following vehicles. The controller 160 may perform a braking operation concurrently with the other vehicles which belong to the same platoon in the same deceleration condition (e.g., operate at a deceleration of −3 m/s² for one second). While executing the final check, the controller 210 may measure an actual deceleration of the host vehicle through the speed detector 130. Further, the controller 210 may measure a time (a control response speed) taken for the actual deceleration of the host vehicle to arrive at 90% of a deceleration requirement of the host vehicle using the timer.

In operation S180, the controller 210 may determine whether a difference between the deceleration requirement and the actual deceleration is within an allowable error range as a result of executing the final check. For example, the controller 210 may determine whether an error between the deceleration requirement and the actual deceleration of the host vehicle is within 5%. When the difference between the deceleration requirement and the actual deceleration is within the allowable error range, the controller 210 may complete (end) the adjustment of the deceleration requirement.

Meanwhile, when the adjustment is not completed with respect to the tail end vehicle in operation S160, in operation S190, the controller 210 may instruct a subsequent following vehicle to adjust through the communication unit 160. In other words, the controller 210 may instruct a following vehicle located immediately after the host vehicle in a platooning line to adjust an amount of braking control.

Meanwhile, when the braking operation of the host vehicle does not meet the adjusting mode in operation S130, in operation S210, the controller 210 may determine whether the braking operation of the host vehicle is an emergency braking operation. When a deceleration of the host vehicle is less than or equal to a threshold (e.g., −3 m/s²), the controller 210 may determine that the braking operation of the host vehicle is the emergency braking operation.

When determining that the braking operation of the host vehicle is the emergency braking operation, in operation S220, the controller 210 may adjust a deceleration requirement of the host vehicle at a predetermined rate. For example, the controller 210 may calculate 1.3 times of the deceleration requirement of the host vehicle as an adjusted deceleration requirement of the host vehicle.

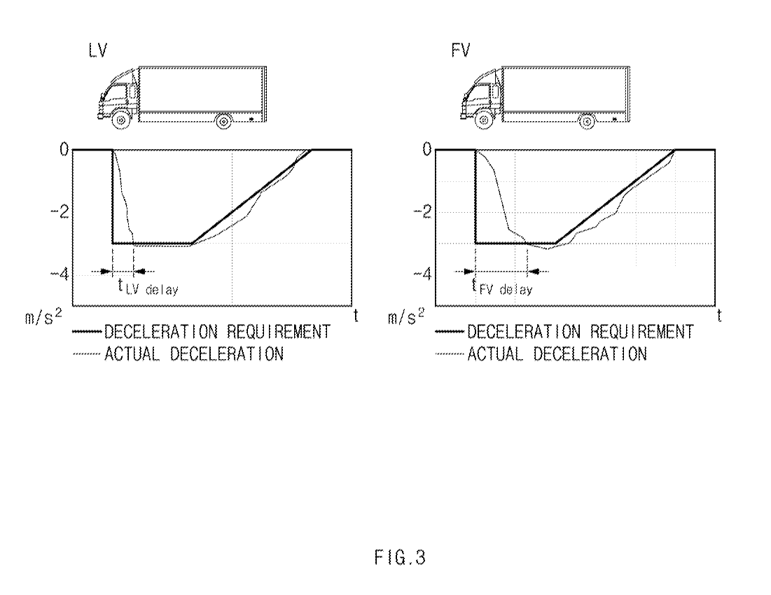

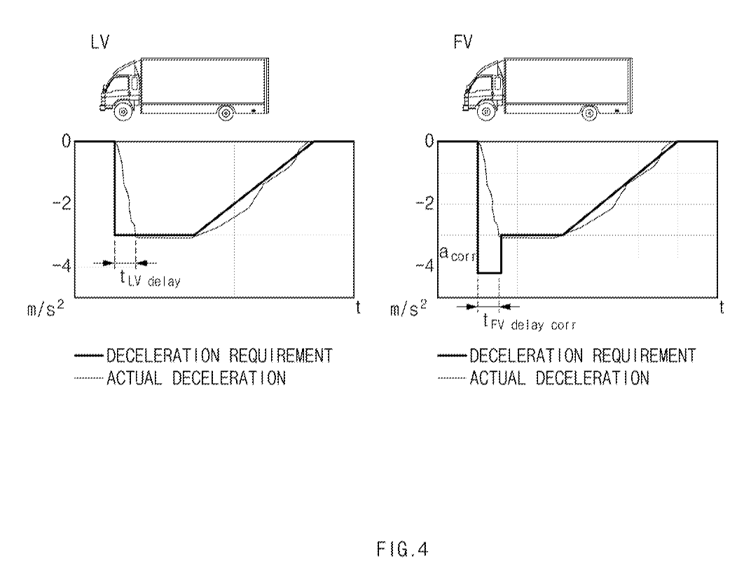

FIG. 3 is a graph illustrating braking performance of a vehicle before adjusting an amount of braking control according to a form of the present disclosure. FIG. 4 is a graph illustrating braking performance of a vehicle according to adjustment of an amount of braking control in some forms of the present disclosure.

As shown in FIG. 3, when each of a leading vehicle LV and a following vehicle FV executes its braking operation at the same deceleration requirement, a deceleration delay time t_{LV delay} of the leading vehicle LV may differ from a deceleration delay time f_{FV delay} of the following vehicle FV. As such, when control responsibility of the leading vehicle LV differs from control responsibility of the following vehicle FV, a phenomenon in which a V2V distance between the leading vehicle LV and the following vehicle FV is suddenly close and distant upon emergency braking may occur. Thus, a driver may be uncomfortable upon platooning, and an accident may occur upon platooning.

Thus, when a method for adjusting an amount of braking control, proposed in the present disclosure, is applied, as shown in FIG. 4, a braking time and a braking value of the leading vehicle LV may be synchronized with a braking time and a braking value of the following vehicle FV. In other word, a vehicle deceleration delay time t_{LV delay} of the leading vehicle LV may be synchronized with a vehicle deceleration delay time t_{FV delay corr} of the following vehicle FV.

The present disclosure may synchronize a braking time and a braking value between platooning vehicles by adjusting an amount of longitudinal control of the host vehicle in consideration of braking performance of each of the preceding vehicle and the host vehicle upon platooning and controlling a V2V distance from the preceding vehicle.

The present disclosure may increase stability by stably maintaining a distance between platooning vehicles.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A platooning control apparatus, the apparatus comprising:
a communication unit configured to perform wireless communication with at least one vehicle that forms a platooning line with a host vehicle;
a detector configured to detect a braking state of the host vehicle; and
a controller configured to adjust an amount of braking control of the host vehicle when a preceding vehicle of the host vehicle is changed, wherein the amount of the braking control of the host vehicle is adjusted based on whether the braking state of the host vehicle meets an adjusting mode and based on a braking performance of each of the preceding vehicle and the host vehicle.

2. The apparatus of claim 1, wherein the communication unit is configured to use vehicle to vehicle (V2V) communication.

3. The apparatus of claim 1, wherein the preceding vehicle is a vehicle immediately before the host vehicle in the platooning line.

4. The apparatus of claim 1, wherein the detector comprises:
a speed detector configured to detect a deceleration of the host vehicle.

5. The apparatus of claim 1, wherein the controller is configured to:
determine whether the deceleration of the host vehicle is within a reference range and is maintained for a predetermined amount of time.

6. The apparatus of claim 5, wherein the controller is configured to calculate a correction value based on:
an initial deceleration requirement of the host vehicle;
a deceleration requirement of the host vehicle;
an actual deceleration of the host vehicle;
a deceleration requirement of the preceding vehicle; and
an actual deceleration of the preceding vehicle.

7. The apparatus of claim 1, wherein the controller is configured to:
when the braking state of the host vehicle does not meet the adjusting mode, determine whether the braking state of the host vehicle is an emergency braking state; and
when it is determined that the braking state of the host vehicle is the emergency braking state, adjust the deceleration requirement of the host vehicle with a predetermined rate.

8. The apparatus of claim 7, wherein the controller is configured to:
adjust the deceleration requirement of the host vehicle to 1.3 times of the deceleration requirement of the host vehicle.

9. The apparatus of claim 1, wherein the controller is configured to:
after adjusting the amount of the braking control of the host vehicle, determine whether the host vehicle is a tail end vehicle of the platooning line;
when it is determined that the host vehicle is the tail end vehicle of the platooning line, check a braking operation of the host vehicle; and
adjust the amount of the braking control of the host vehicle based on the braking operation of the host vehicle.

10. The apparatus of claim 1, wherein the controller is configured to:
when the host vehicle is not the tail end vehicle of the platooning line, instruct a following vehicle to adjust an amount of braking control of the following vehicle.

11. The apparatus of claim 9, wherein the controller is configured to:
control the braking operation of the host vehicle with a predetermined deceleration requirement of the host vehicle for a predetermined amount of time;
measure the actual deceleration of the host vehicle; and
determine whether a difference between the actual deceleration of the host vehicle and the predetermined deceleration requirement of the host vehicle is within an allowable error range.

12. A platooning control method, the method comprising:
when a host vehicle and at least one vehicle form a platooning line, determining whether a preceding vehicle is changed;
when it is determined that the preceding vehicle is changed, determining whether a braking state of the host vehicle meets an adjusting mode;
when it is determined that the braking state of the host vehicle meets the adjusting mode, adjusting an amount of braking control of the host vehicle based on a braking performance of the preceding vehicle; and
controlling braking of the host vehicle based on the amount of the braking control of the host vehicle that is adjusted based on the braking performance of the preceding vehicle.

13. The method of claim 12, wherein the host vehicle is configured to transmit and receive data with the at least one vehicle using vehicle to vehicle (V2V) communication.

14. The method of claim 12, wherein the preceding vehicle is a vehicle immediately before the host vehicle in the platooning line.

15. The method of claim 12, wherein determining whether the braking state of the host vehicle meets the adjusting mode comprises:
determining whether a deceleration of the host vehicle is within a reference range and is maintained for a predetermined amount of time.

16. The method of claim 12, wherein adjusting the amount of the braking control of the host vehicle comprises:
calculating a correction value based on:
an initial deceleration requirement of the host vehicle;
a deceleration requirement of the host vehicle;
an actual deceleration of the host vehicle;
a deceleration requirement of the preceding vehicle; and
an actual deceleration of the preceding vehicle.

17. The method of claim 12, wherein determining whether the braking state of the host vehicle meets the adjusting mode comprises:
when it is determined that the braking state of the host vehicle does not meet the adjusting mode, determining whether the braking state of the host vehicle is an emergency braking state; and
when it is determined that the braking state of the host vehicle is the emergency braking state, calculating the deceleration requirement of the host vehicle based on the deceleration requirement of the preceding vehicle.

18. The method of claim 12, wherein the method further comprises:
after adjusting the amount of the braking control of the host vehicle, determining whether the host vehicle is a tail end vehicle of the platooning line;
when the host vehicle is the tail end vehicle of the platooning line, checking a braking operation of the host vehicle; and
adjusting the amount of the braking control of the host vehicle based on the braking operation of the host vehicle.

19. The method of claim 18, wherein determining whether the host vehicle is the tail end vehicle of the platooning line comprises:
when it is determined that the host vehicle is not the tail end vehicle of the platooning line, instructing a following vehicle to adjust an amount of braking control of the following vehicle.

20. The method of claim 19, wherein checking the braking operation of the host vehicle comprises:
controlling the braking operation of the host vehicle at a predetermined deceleration requirement of the host vehicle for a predetermined amount of time; and
determining whether a difference between the actual deceleration of the host vehicle and the predetermined deceleration requirement of the host vehicle is within an allowable error range.
